(19) United States
(12) Patent Application Publication
(10) Pub. No.: US 2025/0264023 A1
(43) Pub. Date: Aug. 21, 2025

(54) INTERNAL COMBUSTION ENGINE

(71) Applicant: Kangming ZHENG, Wenchang City (CN)

(72) Inventor: Kangming ZHENG, Wenchang City (CN)

(21) Appl. No.: 19/203,922

(22) Filed: May 9, 2025

Related U.S. Application Data
(63) Continuation of application No. PCT/CN2023/084212, filed on Mar. 28, 2023.

(30) Foreign Application Priority Data
Nov. 10, 2022 (CN) 202222983965.X

(51) Int. Cl. F01C 1/356; F01C 11/00; F01C 21/00; F01C 21/08

(52) U.S. Cl. CPC F01C 1/356; F01C 11/004; F01C 21/007; F01C 21/0881

(57) ABSTRACT

An internal combustion engine includes a cylinder block, a fixed arm, a rotor, and multiple rocker arms. The rotor is coaxially rotated and disposed inside the cylinder block. An annular sealed cavity is formed between the outer periphery of the rotor and the inner wall of the cylinder block. The fixed arm is disposed on the inner wall of the cylinder block in a radial direction of the rotor. The multiple rocker arms are disposed on the outer periphery of the rotor in the radial direction of the rotor. The multiple rocker arms are arranged in a circumferential direction of the rotor. During rotation of the rotor, the multiple rocker arms and the fixed arm are configured to mutually avoid each other. A supercharging chamber is in a region inside the sealed cavity and between the fixed arm and one rocker arm on a downstream side of the fixed arm.

### CROSS-REFERENCE TO RELATED APPLICATIONS

This application is a continuation of International Patent Application No. PCT/CN2023/084212, filed on Mar. 28, 2023, which claims priority to Chinese Patent Application No. 202222983965.X, filed on Nov. 10, 2022, the disclosures of both of which are incorporated herein by reference in their entireties.

### TECHNICAL FIELD

The present application relates to the technical field of power machinery, and in particular, to an internal combustion engine.

### BACKGROUND

An internal combustion engine is a type of power-generating machinery that functions as a thermal engine by combusting fuel inside the engine and directly converting the released thermal energy into mechanical power. The commonly referred internal combustion engine typically denotes a reciprocating piston internal combustion engine, in which fuel is mixed with air and combusted within a cylinder. The high-temperature, high-pressure gases produced from the combustion cause the piston to move, and this motion is transmitted through a crank-connecting rod mechanism or other transmission system to generate mechanical output and drive external machinery.

In reciprocating piston engines, the piston in a reciprocating piston internal combustion engine moves linearly, the linear motion of the piston must be converted into the rotational motion of the crankshaft. This conversion process results in multiple sources of energy loss. Firstly, the reciprocating motion of the piston must overcome the friction between itself and the cylinder wall, consuming 1% to 5% of the energy. Secondly, the reciprocating linear motion of the piston requires frequent acceleration and deceleration, consuming 5% to 10% of the energy to overcome the inertial force of the piston, which is particularly significant at high speeds. Furthermore, the force transmission between the piston and the crankshaft occurs through the swinging of the connecting rod. When the piston is not at the top dead center or bottom dead center, the connecting rod forms an angle (swing angle) with the centerline of the cylinder. At this point, the combustion pressure (F) transmitted along the connecting rod can be decomposed into two components, that is, axial thrust (F1) and lateral force (F2). F1 is the effective component along the tangential direction of the crankshaft, which drives the crankshaft to rotate. F2 is the ineffective component that exerts a perpendicular pressure on the cylinder wall and is converted into frictional loss through the piston skirt. Based on trigonometric relationships, the proportion of the lateral force equals sinθ×100%, where θ denotes the swing angle of the connecting rod. Under typical operating conditions (θ˜10°-15°, approximately 20% to 30% of the combustion pressure is converted into lateral force, that is, 20% to 30% of the combustion pressure becomes ineffective force, thereby exacerbating energy loss. Moreover, the transmission efficiency of the crank-connecting rod mechanism near the top and bottom dead centers drops below 5% to 10%, further contributing to energy loss. Due to the preceding reasons, the thermal efficiency of current reciprocating piston internal combustion engines is currently limited to around 40%.

Therefore, there is an urgent need to improve the thermal efficiency of current internal combustion engines.

### SUMMARY

The present application provides an internal combustion engine.

An internal combustion engine includes a cylinder block, a rotor, a fixed arm, and multiple rocker arms.

The cylinder block is provided with a circular inner cavity.

The rotor is coaxially disposed inside the inner cavity and is rotatably connected to the cylinder block. An annular sealed cavity is formed between an outer periphery of the rotor and an inner wall of the cylinder block.

The fixed arm is disposed on the inner wall of the cylinder block in a radial direction of the rotor and is configured to seal a gap between the cylinder block and the rotor.

The multiple rocker arms are disposed on the outer periphery of the rotor in the radial direction of the rotor and are configured to seal the gap between the cylinder block and the rotor. The multiple rocker arms are arranged in a circumferential direction of the rotor. During rotation of the rotor, the multiple rocker arms and the fixed arm are configured to mutually avoid each other.

A supercharging chamber is formed in a region inside the sealed cavity and between the fixed arm and one rocker arm of the multiple rocker arms on a downstream side of the fixed arm. When a position of the fixed arm is fixed and an internal pressure of the supercharging chamber increases, the one rocker arm is pushed to rotate in a direction facing away from the fixed arm to drive the rotor to rotate.

In some embodiments, the cylinder block is provided with an intake port communicating with the supercharging chamber, a spark plug is disposed inside the supercharging chamber, and the cylinder block is provided with an exhaust port located on a downstream side of the supercharging chamber.

In some embodiments, the fixed arm is rotatable relative to the cylinder block, and a rotation axis of the fixed arm is parallel to a rotation axis of the rotor.

In some embodiments, the fixed arm is slidable relative to the cylinder block in an axial direction of the rotor.

In some embodiments, the fixed arm is slidable relative to the cylinder block in the radial direction of the rotor.

In some embodiments, the multiple rocker arms are rotatable relative to the rotor, and a rotation axis of the multiple rocker arms is parallel to the rotation axis of the rotor.

In some embodiments, the multiple rocker arms are slidable relative to the rotor in an axial direction of the rotor.

In some embodiments, the multiple rocker arms are slidable relative to the rotor in the radial direction of the rotor.

In some embodiments, the outer periphery of the rotor is provided with multiple sealing members spaced apart in the circumferential direction of the rotor, one end of each of the rocker arms is rotatably connected between two adjacent sealing members, another end of each of the rocker arms is connected to an extension arm, and the extension arm extends in a direction toward an axis of the rotor.

During the rotation of the rotor, the multiple rocker arms sequentially abut against the fixed arm to enable the multiple rocker arms to rotate to an avoidance state to pass over the fixed arm, and after passing over the fixed arm, the multiple rocker arms are configured to rotate to a sealing state to seal the supercharging chamber.

In some embodiments, the inner wall of the cylinder block is provided with an abutment post for stopping the extension arm, the abutment post is positioned on the downstream side of the fixed arm, and when a rocker arm in the avoidance state abuts against the abutment post, the rocker arm is configured to rotate to a sealing state in which the extension arm abuts against a sealing member.

In some embodiments, multiple slide grooves are arranged on the rotor around a rotation axis of the rotor, the multiple slide grooves are arranged in the radial direction of the rotor, each of the multiple arms is slidably disposed inside a respective slide groove of the multiple slide grooves, the rocker arm is configured to slide to a sealing state to seal the supercharging chamber and an avoidance state to avoid the fixed arm.

In some embodiments, multiple avoidance channels for receiving the multiple rocker arms are disposed on one side of the cylinder block in the axial direction of the rotor, the multiple avoidance channels are arranged in the axial direction of the rotor and are provided in a one-to-one correspondence with the multiple rocker arms, part of each rocker arm is disposed inside a respective avoidance channel of the multiple avoidance channels, and the each rocker arm is configured to slide to a sealing state to seal the supercharging chamber and an avoidance state to avoid the fixed arm.

In some embodiments, a rear cover is slidably disposed on a side of the cylinder block facing away from the multiple avoidance channels, and the rear cover is slidable in the axial direction of the rotor, and a volume of the supercharging chamber is adjustable through sliding the rear cover to regulate a rotational speed and torque of the rotor.

In some embodiments, a circular avoidance cavity is disposed on one side of the inner cavity, the avoidance cavity partially overlaps with the sealed cavity, the fixed arm is rotatably disposed inside the avoidance cavity, the rotation axis of the fixed arm is parallel to the rotation axis of the rotor, the fixed arm is cylindrically shaped and cooperates with an inner wall of the avoidance cavity to achieve sealing, and an outer periphery of the fixed arm is provided with an avoidance groove for receiving the rocker arm.

During the rotation of the rotor, the multiple rocker arms are configured to sequentially enter the avoidance groove and cooperate with an inner wall of the avoidance groove to achieve sealing.

In some embodiments, the bottom of the avoidance groove is arc-shaped, and a side of the rocker arm facing away from the rotor is arc-shaped.

The present application also provides an internal combustion engine. The internal combustion engine includes a cylinder block and a rotor. The rotor is fitted inside the cylinder block. The cylinder block is provided with a fixed arm. The rotor is provided with a rocker arm. The cylinder block, the fixed arm, the rotor, the rocker arm, and a cover are configured to form a sealed space for driving the rotor to rotate. The sealed space is used as a combustion chamber.

In some embodiments, at least one combustion chamber is provided inside the internal combustion engine to enable the rocker arm to perform arcuate motion, thereby performing work.

In some embodiments, the rocker arm or the fixed arm alternately enters the combustion chamber and seals the combustion chamber, and two ways are provided to enter the combustion chamber. One way to enter the combustion chamber is that the rocker arm moves relative to the rotor, and an internal combustion engine in which the rocker arm moves into the combustion chamber is designated as a deformable rotor internal combustion engine. The other way to enter the combustion chamber is that the fixed arm moves relative to the cylinder block, and an internal combustion engine in which the fixed arm moves into the combustion chamber is designated as a deformable cylinder block internal combustion engine. A direction of deformation of the rocker arm or a direction of deformation of the fixed arm has three types, that is, rotational, lateral, and radial.

In some embodiments, the combustion chamber is configured to include a spark plug, a fuel injection port, and an intake port, and the cylinder block or the cover is provided with an exhaust port.

In some embodiments, the rotor and the rocker arm are not rigidly connected, and the rocker arm is movable relative to the rotor.

In some embodiments, the rocker arm on the rotor is retractable toward the center of the rotor into a chamber leading to the center of the rotor, the chamber includes a positive-pressure cavity and a negative-pressure cavity separated from each other, and when the rocker arm communicates with the positive-pressure cavity, the rocker arm is pushed outward, and when the rocker arm communicates with the negative-pressure cavity, the rocker arm is drawn inward.

In some embodiments, the rotor and the rocker arm are connected by a pin, one end of the rocker arm is rotatable around the pin, and when all rocker arms on the rotor are closed, a circular shape with a notch is formed in both a projection and a radial cross-section.

In some embodiments, the rocker arm is movable in an axial direction of the rotor, and a rear cover is also movable in the axial direction, thereby changing an axial size of the combustion chamber and altering a force-bearing area of the rocker arm, so as to achieve continuously variable transmission.

In some embodiments, the cylinder block and the fixed arm on the cylinder block are not rigidly connected, and the fixed arm is movable in coordination with the rocker arm to maintain the combustion chamber sealed.

### BRIEF DESCRIPTION OF DRAWINGS

FIG. 1 is an exploded view of embodiment one of the present application.

FIG. 2 is a view illustrating the structure of embodiment one of the present application.

FIG. 3 is a view illustrating the structure of embodiment two of the present application.

FIG. 4 is an exploded view of embodiment three of the present application.

FIG. 5 is a view illustrating the structure of embodiment four of the present application.

FIG. 6 is a view illustrating the structure of embodiment five of the present application.

FIG. 7 is a sectional view of embodiment six of the present application.

FIG. 8 is a view illustrating the structure of embodiment six of the present application.

### REFERENCE LIST

1 cylinder block
11 body
12 front cover
13 rear cover
131 abutment post
132 fixing rod
2 fixed arm
21 avoidance groove
3 rotor
31 rotation shaft
32 turntable
321 sealing member
33 slide groove
34 sealing column
4 rocker arm
41 extension arm
51 sealed cavity
52 supercharging chamber
53 intake port
54 exhaust port
6 avoidance column
61 avoidance channel
7 drive cover
71 drive cavity
8 avoidance cavity

### DETAILED DESCRIPTION

The present application is further described hereinafter in detail in conjunction with drawings and embodiments. The embodiments described herein are intended to explain the present application and not to limit the present application. Additionally, it is to be noted that for ease of description, only part, not all, of the structures related to the present application are illustrated in the drawings.

In the description of the present application, unless otherwise expressly specified and limited, the term “connected to each other”, “connected”, or “secured” is to be construed in a broad sense, for example, as securely connected, detachably connected, or integrated; mechanically connected or electrically connected; directly connected to each other or indirectly connected to each other via an intermediary; or internally connected between two components or interaction relations between two components. For those of ordinary skill in the art, specific meanings of the preceding terms in the present application may be construed based on specific situations.

In the present application, unless otherwise expressly specified and limited, when a first feature is described as “above” or “below” a second feature, the first feature and the second feature may be in direct contact or be in contact via another feature between the two features. Moreover, when the first feature is “on”, “above”, or “over” the second feature, the first feature is right on, above, or over the second feature, or the first feature is obliquely on, above, or over the second feature, or the first feature is simply at a higher level than the second feature. When the first feature is “under”, “below”, or “underneath” the second feature, the first feature is right under, below, or underneath the second feature, or the first feature is obliquely under, below, or underneath the second feature, or the first feature is simply at a lower level than the second feature.

In the description of the embodiments, the orientation or position relationships indicated by terms “above”, “below”, “right”, and the like are based on the orientation or position relationships shown in the drawings, only for ease of description and simplifying an operation, and these relationships do not indicate or imply that the referred device or element has a specific orientation and is constructed and operated in a specific orientation, and thus it is not to be construed as limiting the present application. In addition, terms “first” and “second” are used only to distinguish between descriptions and have no special meaning.

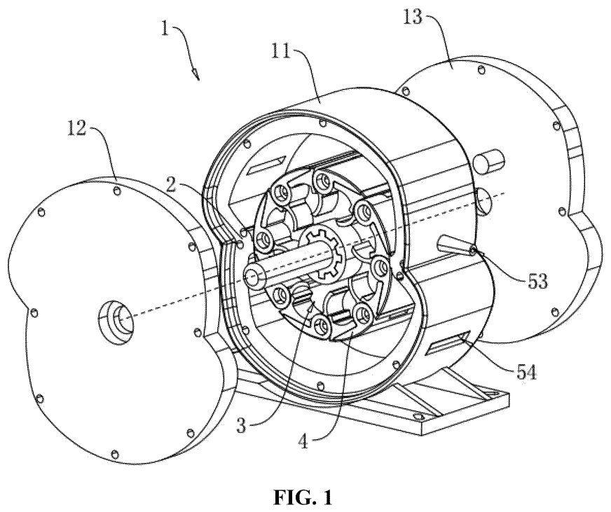

The internal combustion engine provided by the present invention is described below with reference to FIGS. 1 to 8.

With reference to FIGS. 1 to 8, the internal combustion engine includes a cylinder block 1, a fixed arm 2, a rotor 3, and multiple rocker arms 4; the cylinder block 1 has a circular inner cavity, and the rotor 3 is coaxially disposed inside the inner cavity; the rotor 3 is rotatably connected to the cylinder block 1, and an annular sealed cavity 51 is formed between the outer periphery of the rotor 3 and the inner wall of the cylinder block 1. The fixed arm 2 is disposed in the inner cavity in the radial direction of the rotor 3 and seals the gap between the cylinder block 1 and the rotor 3. The rocker arms 4 are disposed on the outer periphery of the rotor 3 in the radial direction of the rotor 3 and seal the gap between the cylinder block 1 and the rotor 3. Multiple rocker arms 4 are arranged in a circumferential direction of the rotor 3. During the rotation of the rotor 3, the multiple rocker arms 4 and the fixed arm 2 are configured to mutually avoid each other. A supercharging chamber 52 is formed in a region inside the sealed cavity 51 and between the fixed arm 2 and one rocker arm 4 on a downstream side of the fixed arm 2.

Thus, an annular sealed cavity 51 is formed between the outer periphery of the rotor 3 and the inner wall of the cylinder block 1, and a region within the sealed cavity 51 and corresponding to the space between the fixed arm 2 and the rocker arm 4 forms a supercharging chamber 52 with a smaller volume. When the position of the fixed arm 2 is fixed and the internal pressure of the supercharging chamber 52 increases, the pressure acts on the rotatable rocker arm 4, thereby driving the rocker arm 4 to rotate and thus causing the rotor 3 to rotate. Additionally, during the rotation of the rotor 3, the rocker arms 4 and the fixed arm 2 can mutually avoid each other so that the rotor 3 can perform a full rotation without being restricted by the fixed arm 2.

In this embodiment, a combustible mixture is introduced into the supercharging chamber 52 so that when the combustible mixture within the supercharging chamber 52 is ignited, the internal pressure of the supercharging chamber 52 can be rapidly increased, thereby directly driving the rocker arm 4 to rotate. Compared with traditional reciprocating piston internal combustion engines, the combustion pressure of the combustible mixture directly drives the rotor 3 to rotate without the need for transmission through components, significantly improving transmission efficiency and thus enhancing the thermal efficiency of the internal combustion engine. This reduces operating costs of the internal combustion engine and achieves low-carbon emissions. Additionally, the internal combustion engine of the present application does not require compression of the combustible mixture, that is, the compression stage is eliminated, which prevents detonation inside the supercharging chamber 52. As a result, the engine imposes lower requirements on fuel and is compatible with various fuels such as natural gas, gasoline, and diesel. This further reduces fuel costs and overcomes the limitation of reliance on a single type of fuel.

In some other embodiments, a fluid with a certain pressure can be introduced into the supercharging chamber 52 to drive the rotor 3 to rotate, thereby converting the kinetic energy of the fluid into the torque output of the rotor 3 to drive other machinery, such as a generator, to perform work.

Further, the cylinder block 1 includes a front cover 12, a body 11, and a rear cover 13 that are sequentially arranged in the axial direction of the rotor 3. The body 11 has a circular inner cavity. The front cover 12 and the rear cover 13 seal two sides of the body 11. The cylinder block 1 is provided with an intake port 53 communicating with the supercharging chamber 52, and external air participating in combustion can enter the supercharging chamber 52 through the intake port 53. The sealing method at the intake port 53 may refer to the sealing method of intake ports in existing internal combustion engines and is not described in detail here. The cylinder block 1 is provided with an exhaust port 54 located on the downstream side of the supercharging chamber 52. The sealing method at the exhaust port 54 may refer to the sealing method of exhaust ports in existing internal combustion engines and is not described in detail here. A spark plug is disposed inside the supercharging chamber 52 for igniting the combustible mixture. The specific structure and installation method of the spark plug may refer to the specific structure and installation method of the spark plugs in existing internal combustion engines and are not described in detail here. A fuel injector is disposed inside the supercharging chamber 52 for injecting fuel such as gasoline into the supercharging chamber 52. The specific structure and installation method of the fuel injector may refer to the specific structure and installation method of the fuel injectors in existing internal combustion engines and are not described in detail here.

In this embodiment, the mutual avoidance of the rocker arm 4 and the fixed arm 2 refers to the movement of the rocker arm 4 relative to the fixed arm 2 and/or the movement of the fixed arm 2 relative to the rocker arm 4, that is, either the rocker arm 4 or the fixed arm 2 moves, or both move simultaneously. The movement configuration of the rocker arm 4 relative to the fixed arm 2 and/or the movement of the fixed arm 2 relative to the rocker arm 4 includes one of the follows: the fixed arm 2 is rotatably connected to the cylinder block 1, and the rotation axis of the fixed arm 2 is parallel to the rotation axis of the rotor 3;, the fixed arm 2 is slidably connected to the cylinder block 1 in the axial direction of the rotor 3; the fixed arm 2 is slidably connected to the cylinder block 1 in the radial direction of the rotor 3; the rocker arm 4 is rotatably connected to the rotor 3, and the rotation axis of the rocker arm 4 is parallel to the rotation axis of the rotor 3; the rocker arm 4 is slidably connected to the rotor 3 in the axial direction of the rotor 3; or, the rocker arm 4 is slidably connected to the rotor 3 in the radial direction of the rotor 3.

The beneficial effects of the present application are described below.

The internal combustion engine of the present application includes a sealed and variable-volume supercharging chamber between the cylinder block and the rotor. When the supercharging chamber contains a combustible mixture and the position of the fixed arm is fixed, the combustible mixture is ignited, and the combustion pressure of the combustible mixture rapidly increases the internal pressure of the supercharging chamber, directly driving the rocker arm to rotate. Since the rocker arm and the fixed arm can mutually avoid each other, continuous rotation of the rotor is achieved. Compared with traditional reciprocating piston internal combustion engines, the combustion pressure of the combustible mixture directly drives the rotor to rotate without the need for transmission through components, significantly improving transmission efficiency and thus enhancing the thermal efficiency of the internal combustion engine. This reduces the operating costs of the internal combustion engine and achieves low-carbon emissions. Additionally, the combustion in the internal combustion engine of the present application is continuous, which prevents detonation inside the supercharging chamber. As a result, the engine imposes lower requirements on fuel and is compatible with various fuels such as natural gas, gasoline, and diesel. This further reduces fuel costs and overcomes the limitation of reliance on a single type of fuel.

The internal combustion engine of the present application also functions similarly to a hydraulic torque converter. With a constant fuel injection amount, when the engine load is high, the rotation angle of the rotor decreases to increase torque; when the load is low, the rotation angle of the rotor increases to reduce torque. In contrast, a reciprocating piston internal combustion engine requires a full 180-degree rotation for each power stroke. Under high load, failure to complete the 180-degree rotation results in stalling, while under low load, excess power is expelled without performing useful work.

Furthermore, a fluid with a certain pressure can be introduced into the supercharging chamber to drive the rotor to rotate, thereby converting the kinetic energy of the fluid into the torque output of the rotor to drive other machinery, such as a generator, to perform work.

The present application is further described below in conjunction with specific embodiments.

### Embodiment One

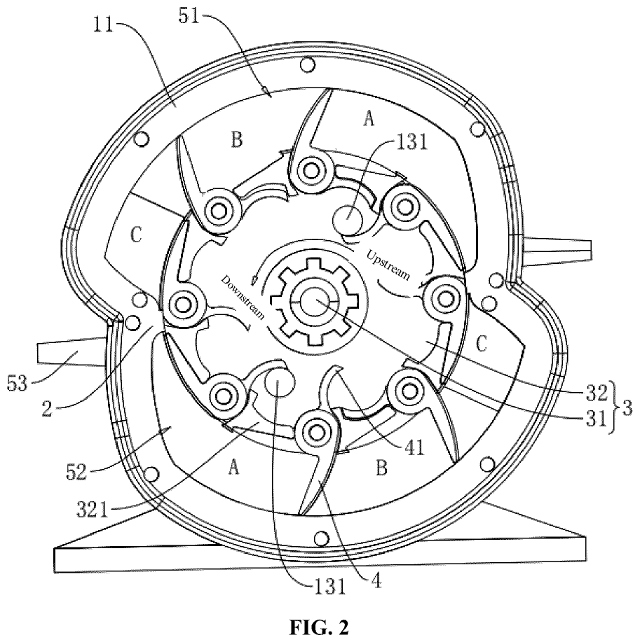

With reference to FIGS. 1 and 2, in this embodiment, the rocker arm 4 is rotatably connected to the rotor 3. In some embodiments, the inner wall of the cylinder block 1 is integrally formed with a protrusion extending into the inner cavity to form the fixed arm 2. The rotor 3 includes a rotation shaft 31 and a turntable 32 arranged coaxially. The outer periphery of the turntable 32 is connected to multiple sealing members 321 disposed at intervals in the circumferential direction of the rotor 3. The sealing members 321 are sealing blocks, and the sealing blocks abut against the front cover 12 and the rear cover 13 on two sides of the axial direction of the rotor 3. In this embodiment, eight rocker arms 4 are provided, and one end of each rocker arm 4 is rotatably connected between two adjacent sealing members 321 and cooperates with the sealing members 321 to achieve sealing. In the axial direction of the rotor 3, the dimensions of the body 11, the sealing members 321, and the rocker arms 4 are consistent, thereby ensuring the sealing between the rotor 3 and the front cover 12 as well as between the rotor 3 and the rear cover 13. Ultimately, a sealed fit between the two ends of the rotor 3 and the inner wall of the cylinder block 1 is achieved.

Further, one end of the rocker arm 4 is connected to an extension arm 41, and the extension arm 41 extends in a direction toward the axis of the rotor 3. The angle between the rocker arm 4 and the extension arm 41 is 70° to 100°, and 90° is used as an example in this embodiment. The inner wall of the rear cover 13 is connected to an abutment post 131 for stopping the extension arm 41, and one abutment post 131 is disposed on the downstream side of each fixed arm 2.

Based on the above, this embodiment is described with an example where two fixed arms 2 are evenly arranged in the circumferential direction of the rotor 3 and eight rocker arms 4 are evenly arranged in the circumferential direction of the rotor 3. During the rotation of the rotor 3, the rocker arm 4 abuts against the fixed arm 2 on the downstream side of the rocker arm 4, causing the rocker arm 4 to rotate to a state of fitting against the sealing block. In this manner, the rocker arm 4 does not protrude from the rotor 3 and can smoothly pass over the fixed arm 2. The rocker arm 4 is in an avoidance state. Subsequently, the rotor 3 continues to rotate until the extension arm 41 of the rocker arm 4 abuts against the abutment post 131, causing the rocker arm 4 to rotate to a state where the extension arm 41 fits closely against the sealing block. In this manner, the rocker arm 4 protrudes from the rotor 3 and cooperates with the cylinder block 1 to achieve sealing. The rocker arm 4 is in a sealing state.

When the rocker arm 4 passes over the fixed arm 2 and is in the sealing state, the space inside the sealed cavity 51 and corresponding to the region between the rocker arm 4 and the fixed arm 2 forms a sealed supercharging chamber 52. At this point, igniting the combustible mixture inside the supercharging chamber 52 causes the combustion pressure of the combustible mixture to act directly on the rocker arm 4, thereby directly driving the rotor 3 to rotate.

When the rocker arm 4 entering the supercharging chamber 52 is fully extended, the rocker arm 4 replaces the previous rocker arm 4 to perform work. At this time, six (three pairs of) mutually isolated spaces, that is, A, B, and C, are formed inside the cylinder block 1. When the rocker arm 4 between spaces B and C rotates to a fixed angle, the high-pressure gas in space B blows toward the rocker arm 4 between spaces B and C, causing the rocker arm 4 to close.

### Embodiment Two

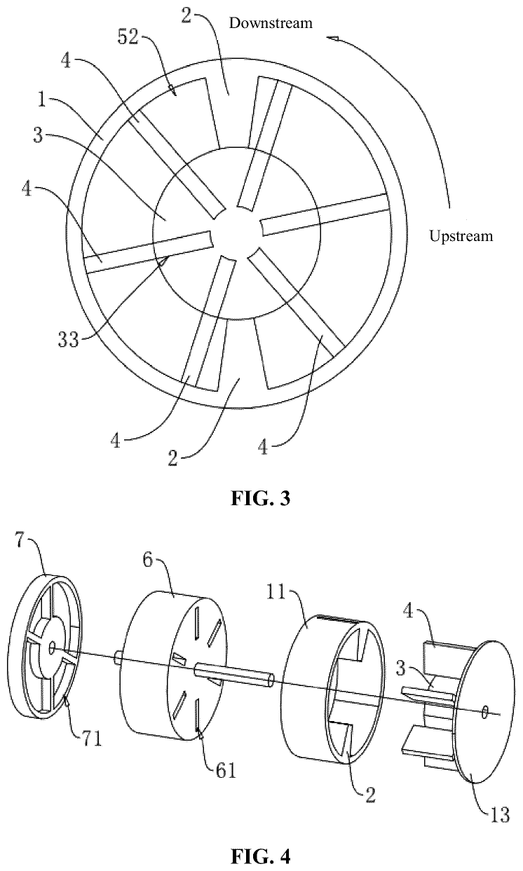

With reference to FIG. 3, the difference between this embodiment and embodiment one lies in that the rocker arm 4 is slidably connected to the rotor 3 in the radial direction of the rotor 3.

In some embodiments, the rotor 3 is cylindrically shaped, and two ends of the rotor 3 cooperate with the front cover 12 and the rear cover 13 to achieve sealing. Multiple slide grooves 33 are formed on the rotor 3 around the rotation axis of the rotor 3, and six slide grooves are used as an example in this embodiment. The slide grooves 33 are arranged in the radial direction of the rotor 3. A rocker arm 4 is slidably disposed inside each slide groove 33. The rocker arm 4 is configured to slide to a sealing state to seal the supercharging chamber 52 and an avoidance state to avoid the fixed arm 2. The sliding of the rocker arm 4 is achieved by pressurizing or applying negative pressure inside the slide groove 33.

Based on the above, during the rotation of the rotor 3, when the rocker arm 4 reaches the upstream side of the fixed arm 2, the rocker arm 4 is drawn into the slide groove 33 to switch to an avoidance state to avoid the fixed arm 2. After passing over the fixed arm 2, the rocker arm 4 is pushed out of the slide groove 33 and switches to a sealing state to seal the supercharging chamber 52. At this point, the combustible mixture inside the supercharging chamber 52 can be ignited to drive the rocker arm 4 to rotate.

### Embodiment Three

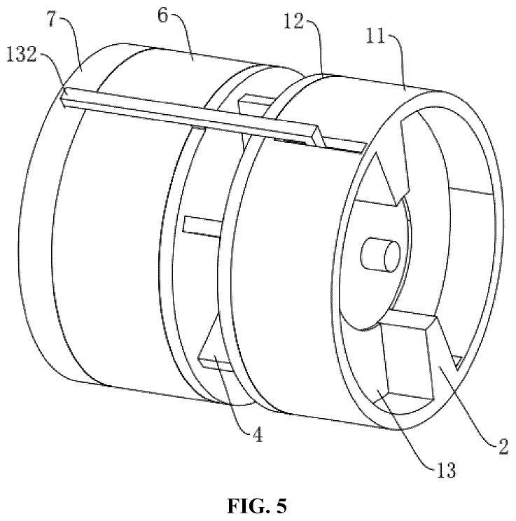

With reference to FIG. 4, the difference between this embodiment and embodiment one lies in that the rocker arm 4 is slidably connected to the rotor 3 in the axial direction of the rotor 3.

In some embodiments, multiple avoidance channels 61 for receiving the rocker arms 4 are disposed on the side of the front cover 12 facing away from the rear cover 13. The multiple avoidance channels 61 are evenly distributed around the axis of the rotor 3, and each avoidance channel 61 is arranged in the circumference of the rotation axis. In this embodiment, an avoidance column 6 is fixedly connected to the front cover 12, and the avoidance channels 61 are formed on the avoidance column 6. In this embodiment, six avoidance channels 61 and six rocker arms 4 are provided, and the six avoidance channels 61 are provided in a one-to-one correspondence with the six rocker arms 4. Part of each rocker arm 4 passes through the front cover 12 and is disposed inside the avoidance channel 61. The rocker arm 4 can slide to a sealing state to seal the supercharging chamber 52 and an avoidance state to avoid the fixed arm 2.

Further, to achieve the sliding of the rocker arm 4, a drive cover 7 is connected to the side of the avoidance column 6 facing away from the front cover 12. The drive cover 7 is rotatably connected to the avoidance column 6, and the axis of the drive cover 7 is coaxial with the axis of the rotor 3. Four drive cavities 71 are formed at intervals on the side of the drive cover 7 close to the avoidance column 6. The four drive cavities 71 are evenly distributed around the axis of the rotor 3. The side of the avoidance channel 61 facing away from the front cover 12 communicates with the drive cavities 71. The four drive cavities 71 are sequentially a positive-pressure cavity, a negative-pressure cavity, a positive-pressure cavity, and a negative-pressure cavity. The two negative-pressure cavities are located on the upstream side of the two fixed arms 2, respectively. The volume of the positive-pressure cavity is greater than that of the negative-pressure cavity. A high-pressure pump maintains a pressure difference between the positive-pressure and negative-pressure cavities.

Based on the above, during the rotation of the rotor 3, when the rocker arm 4 reaches the upstream side of the fixed arm 2, the avoidance channel 61 in which the rocker arm 4 is located communicates with the negative-pressure cavity, thereby drawing the rocker arm 4 into the avoidance channel 61 and placing the rocker arm 4 in an avoidance state to avoid the fixed arm 2. Subsequently, when the avoidance channel 61 in which the rocker arm 4 is located communicates with the positive-pressure cavity, the rocker arm 4 is pushed out of the avoidance channel 61, thereby placing the rocker arm 4 in a sealing state to seal the supercharging chamber 52. At this point, the combustible mixture inside the supercharging chamber 52 can be ignited to drive the rocker arm 4 to rotate. The rocker arm 4 bypasses the fixed arm 2 and enters the supercharging chamber 52 through a suction-and-pressure mechanism.

### Embodiment Four

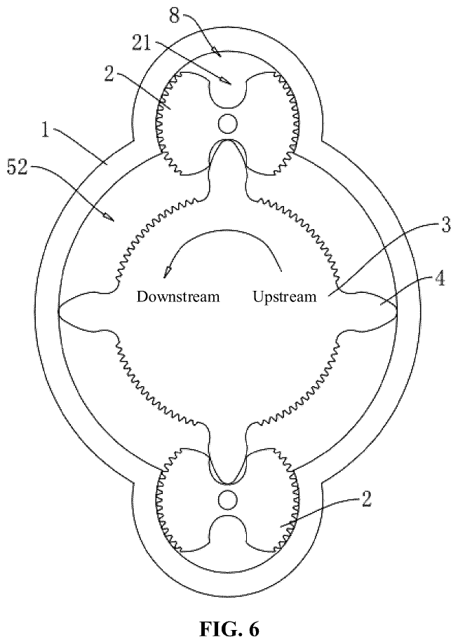

With reference to FIG. 5, the difference between this embodiment and embodiment three lies in that the rear cover 13 is slidably disposed inside the cylinder block 1, and avoidance holes are formed at positions corresponding to the fixed arm 2 and the rotor 3 so that the rear cover 13 can slide in the axial direction of the rotor 3, and circumferential positioning of the rear cover 13 is achieved. The sliding of the rear cover 13 may be driven by a driving component such as an electric cylinder.

A slide groove is formed on the cylinder block 1 in the axial direction of the rotor 3. Two fixing rods 132 are fixedly connected to the rear cover 13 in the circumferential direction of the rear cover 13. One end of the fixing rod 132 is connected to the rear cover 13 through the slide groove, and the other end of the fixing rod 132 is slidably connected to the drive cover 7, thereby circumferentially limiting the drive cover 7.

Thus, by the sliding of the rear cover 13, the axial length of the supercharging chamber 52 along the rotor 3 changes, thereby adjusting the volume of the supercharging chamber 52. With a constant mass of the combustible mixture, changing the volume of the supercharging chamber 52 alters the pressure generated during combustion of the combustible mixture. Higher pressure results in a faster rotational speed of the rotor 3 and greater torque. Without changing the internal pressure of the supercharging chamber 52, the thrust applied to the rocker arm 4 may be altered, thereby achieving continuously variable transmission of the rotor 3.

### Embodiment Five

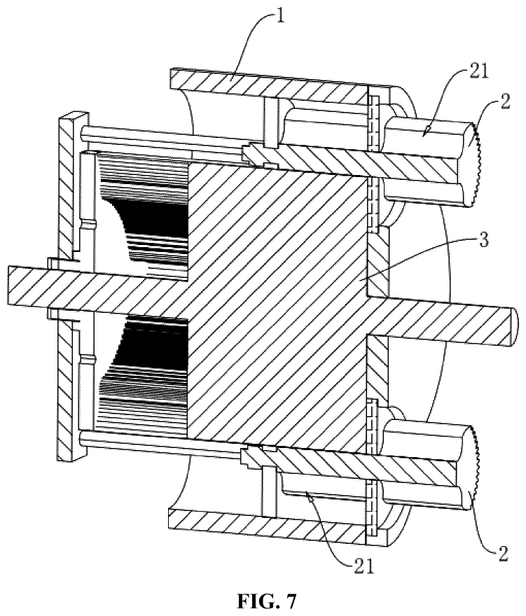

With reference to FIG. 6, the difference between this embodiment and embodiment one lies in that the fixed arm 2 is rotatably connected to the cylinder block 1, the rotation axis of the fixed arm 2 is coaxial with the rotation axis of the rotor 3, and the rocker arm 4 is fixedly connected to the rotor 3.

In some embodiments, an avoidance cavity 8 is disposed on one side of the sealed cavity 51, the avoidance cavity 8 partially overlaps with the sealed cavity 51, and the side of the avoidance cavity 8 facing away from the sealed cavity 51 is arc-shaped. In this embodiment, two avoidance cavities 8 are evenly arranged in the circumferential direction of the rotor 3. The fixed arm 2 is rotatably disposed inside the avoidance cavity 8. The rotation axis of the fixed arm 2 is parallel to the rotation axis of the rotor 3. The fixed arm 2 is cylindrically shaped and cooperates with an inner wall of the avoidance cavity 8 to achieve sealing. The outer periphery of the fixed arm 2 is provided with an avoidance groove 21 for receiving the rocker arm 4. The bottom of the avoidance groove 21 is arc-shaped. Two avoidance grooves are used as an example in this embodiment.

The side of the rocker arm 4 facing away from the rotor 3 is arc-shaped. During the rotation of the rotor 3, the multiple rocker arms 4 can sequentially enter the avoidance groove 21 and cooperate with the inner wall of the avoidance groove 21 to achieve sealing. In this manner, the rocker arm 4 and the rotor 3 form a rotor assembly resembling a pair of meshing gears. When the supercharging chamber 52 is formed by one rocker arm 4, the rocker arm 4 is subjected to thrust on one side and generates torque. When the supercharging chamber 52 is formed by two rocker arms 4 (during arm switching), the rotor assembly experiences zero torque. However, the fixed arm 2 generates torque, which can still drive the rotor assembly to rotate. The internal combustion engine in this embodiment exhibits both central symmetry and axial symmetry, facilitating forward and reverse rotation.

### Embodiment Six

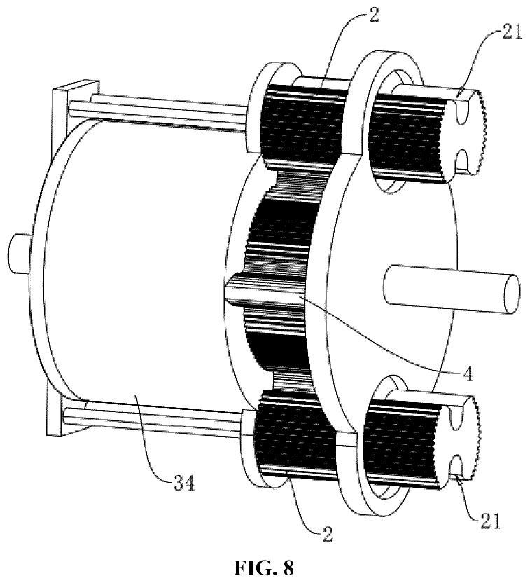

With reference to FIGS. 7 and 8, this embodiment is an improvement over embodiment five, and the differences are as follows: 1. The fixed arm 2 may extend outside the cylinder block 1. 2. The “rear cover” 13 is “synthetic” and may move axially inside the cylinder block 1. In this manner, the axial size of the supercharging chamber can be changed, and a continuously variable transmission can be achieved.

Apparently, the preceding embodiments of the present application are only illustrative of the present application and are not intended to limit the implementations of the present application. Those of ordinary skill in the art can make various apparent modifications, adaptations, and substitutions without departing from the scope of the present application. All embodiments cannot be and do not need to be exhausted herein. Any modifications, equivalent substitutions, and improvements made within the spirit and principle of the present application fall within the scope of the claims of the present application.

What is claimed is:

1. An internal combustion engine, comprising:
a cylinder block provided with a circular inner cavity;
a rotor coaxially disposed inside the inner cavity, wherein the rotor is rotatably connected to the cylinder block, and an annular sealed cavity is formed between an outer periphery of the rotor and an inner wall of the cylinder block;
a fixed arm disposed on the inner wall of the cylinder block in a radial direction of the rotor and configured to seal a gap between the cylinder block and the rotor; and
a plurality of rocker arms disposed on the outer periphery of the rotor in the radial direction of the rotor and configured to seal the gap between the cylinder block and the rotor, wherein the plurality of rocker arms are arranged in a circumferential direction of the rotor, and during rotation of the rotor, the plurality of rocker arms and the fixed arm are configured to mutually avoid each other;
wherein a supercharging chamber is in a region inside the sealed cavity and between the fixed arm and one rocker arm of the plurality of rocker arms on a downstream side of the fixed arm, and when a position of the fixed arm is fixed and an internal pressure of the supercharging chamber increases, the one rocker arm is pushed to rotate in a direction facing away from the fixed arm to drive the rotor to rotate.

2. The internal combustion engine according to claim 1, wherein the cylinder block is provided with an intake port communicating with the supercharging chamber, a spark plug is disposed inside the supercharging chamber, and the cylinder block is provided with an exhaust port located on a downstream side of the supercharging chamber.

3. The internal combustion engine according to claim 2, wherein one of the following configurations is satisfied:
the fixed arm is rotatable relative to the cylinder block, and a rotation axis of the fixed arm is parallel to a rotation axis of the rotor;
the fixed arm is slidable relative to the cylinder block in an axial direction of the rotor;
the fixed arm is slidable relative to the cylinder block in the radial direction of the rotor;
the plurality of rocker arms are rotatable relative to the rotor, and a rotation axis of the plurality of rocker arms is parallel to the rotation axis of the rotor;
the plurality of rocker arms are slidable relative to the rotor in an axial direction of the rotor; or
the plurality of rocker arms are slidable relative to the rotor in the radial direction of the rotor.

4. The internal combustion engine according to claim 3, wherein the outer periphery of the rotor is provided with a plurality of sealing members spaced apart in the circumferential direction of the rotor, one end of each of the plurality of rocker arms is rotatably connected between two adjacent sealing members, another end of each of the plurality of rocker arms is connected to an extension arm, and the extension arm extends in a direction toward an axis of the rotor; and
during the rotation of the rotor, the plurality of rocker arms sequentially abut against the fixed arm to enable the plurality of rocker arms to rotate to an avoidance state to pass over the fixed arm, and after passing over the fixed arm, the plurality of rocker arms are configured to rotate to a sealing state to seal the supercharging chamber.

5. The internal combustion engine according to claim 4, wherein the inner wall of the cylinder block is provided with an abutment post for stopping the extension arm, the abutment post is positioned on the downstream side of the fixed arm, and when a rocker arm of the plurality of rocker arms in the avoidance state abuts against the abutment post, the rocker arm is configured to rotate to a sealing state in which the extension arm abuts against a sealing member of the plurality of sealing members.

6. The internal combustion engine according to claim 3, wherein a plurality of slide grooves are disposed on the rotor around a rotation axis of the rotor, the plurality of slide grooves are arranged in the radial direction of the rotor, each of the plurality of rocker arms is slidably disposed inside a respective slide groove of the plurality of slide grooves, the rocker arm is configured to slide to a sealing state to seal the supercharging chamber and an avoidance state to avoid the fixed arm.

7. The internal combustion engine according to claim 3, wherein a plurality of avoidance channels for receiving the plurality of rocker arms are disposed on one side of the cylinder block in the axial direction of the rotor, the plurality of avoidance channels are arranged in the axial direction of the rotor and are provided in a one-to-one correspondence with the plurality of rocker arms, part of each of the plurality of rocker arms is disposed inside a respective avoidance channel of the plurality of avoidance channels, and each of the plurality of rocker arms is configured to slide to a sealing state to seal the supercharging chamber and an avoidance state to avoid the fixed arm.

8. The internal combustion engine according to claim 7, wherein a rear cover is slidably disposed on a side of the cylinder block facing away from the plurality of avoidance channels, and the rear cover is slidable in the axial direction of the rotor; and
a volume of the supercharging chamber is adjustable through sliding the rear cover to regulate a rotational speed and torque of the rotor.

9. The internal combustion engine according to claim 3, wherein a circular avoidance cavity is disposed on one side of the inner cavity, the avoidance cavity partially overlaps with the sealed cavity, the fixed arm is rotatably disposed inside the avoidance cavity, the rotation axis of the fixed arm is parallel to the rotation axis of the rotor, the fixed arm is cylindrically shaped and cooperates with an inner wall of the avoidance cavity to achieve sealing, and an outer periphery of the fixed arm is provided with an avoidance groove for receiving a rocker arm of the plurality of rocker arms; and
during the rotation of the rotor, the plurality of rocker arms are configured to sequentially enter the avoidance groove and cooperate with an inner wall of the avoidance groove to achieve sealing.

10. The internal combustion engine according to claim 3, wherein a bottom of the avoidance groove is arc-shaped, and a side of each of the plurality of rocker arms facing away from the rotor is arc-shaped.

11. An internal combustion engine, comprising a cylinder block and a rotor, wherein the rotor is fitted inside the cylinder block, the cylinder block is provided with a fixed arm, the rotor is provided with a rocker arm, the cylinder block, the fixed arm, the rotor, the rocker arm, and a cover are configured to form a sealed space for driving the rotor to rotate, and the sealed space is used as a combustion chamber.

12. The internal combustion engine according to claim 11, wherein at least one combustion chamber is provided inside the engine to enable the rocker arm to perform arcuate motion, thereby performing work.

13. The internal combustion engine according to claim 12, wherein the rocker arm or the fixed arm alternately enters the combustion chamber and seals the combustion chamber;
the internal combustion engine is configured with two ways to enter the combustion chamber: one way of the two ways to enter the combustion chamber is that the rocker arm moves relative to the rotor, and an internal combustion engine in which the rocker arm moves into the combustion chamber is a deformable rotor internal combustion engine; the other way of the two ways to enter the combustion chamber is that the fixed arm moves relative to the cylinder block, and an internal combustion engine in which the fixed arm moves into the combustion chamber is a deformable cylinder block internal combustion engine; and
a direction of deformation of the rocker arm or a direction of deformation of the fixed arm has three types: rotational, lateral, and radial.

14. The internal combustion engine according to claim 12, wherein the combustion chamber is configured to comprise a spark plug, a fuel injection port, and an intake port, and the cylinder block or the cover is provided with an exhaust port.

15. The internal combustion engine according to claim 13, wherein the rotor and the rocker arm are not rigidly connected, and the rocker arm is movable relative to the rotor.

16. The internal combustion engine according to claim 13, wherein the rocker arm on the rotor is retractable toward a center of the rotor into a chamber leading to the center of the rotor, the chamber comprises a positive-pressure cavity and a negative-pressure cavity separated from each other, and
when the rocker arm communicates with the positive-pressure cavity, the rocker arm is pushed outward, and when the rocker arm communicates with the negative-pressure cavity, the rocker arm is drawn inward.

17. The internal combustion engine according to claim 13, wherein the rotor and the rocker arm are connected by a pin, one end of the rocker arm is rotatable around the pin, and when all rocker arms on the rotor are closed, a circular shape with a notch is formed in both a projection and a radial cross-section.

18. The internal combustion engine according to claim 13, wherein the rocker arm is movable in an axial direction of the rotor, and a rear cover is also movable in the axial direction, thereby changing an axial size of the combustion chamber and altering a force-bearing area of the rocker arm, so as to achieve continuously variable transmission.

19. The internal combustion engine according to claim 12, wherein the cylinder block and the fixed arm on the cylinder block are not rigidly connected, and the fixed arm is movable in coordination with the rocker arm to maintain the combustion chamber to be sealed.
